(19) United States
(12) Patent Application Publication
(10) Pub. No.: US 2014/0368161 A1
(43) Pub. Date: Dec. 18, 2014

(54) BATTERY LIFE OF PORTABLE ELECTRONIC DEVICES

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/919,567

(22) Filed: Jun. 17, 2013

(51) Int. Cl. H02J 7/02

(52) U.S. Cl. CPC H02J 7/025
USPC 320/108

(57) ABSTRACT

The present disclosure provides a method for improving battery life of electronic devices such as Bluetooth headsets, smart-watches among others running on small batteries, for example coin batteries. The method may include wireless power transmission through suitable techniques such as pocket-forming, while including receivers and capacitors in the aforementioned devices. Wirelessly charged capacitors may provide sufficient power on which devices may run, and thus, battery life of such electronic devices may be enhanced.

### CROSS-REFERENCES TO RELATED APPLICATIONS

The present disclosure is related to U.S. Non-Provisional patent application Ser. No. 13/891,340 filed May 10, 2013, entitled Methodology for Pocket-Forming, the entire content of which is incorporated herein by this reference.

### FIELD OF INVENTION

The present disclosure relates to wireless power transmission, and more particularly to wireless power transmission for improving battery life of portable electronic devices

### BACKGROUND OF THE INVENTION

Electronic devices such as headsets, small-watches, light key-chains and other such equipment may include batteries, for example coin batteries, for performing their intended functions. When batteries run out, the foregoing devices may be inoperable and can effectively turn unusable. This may be a burden for users which may need to carry extra batteries, whenever they go out, in case the aforementioned electronic devices run out of power. In the worst case scenario, batteries in such devices may not be replaceable. Thus, these devices may no longer be useful and may therefore be disposed as waste. This may have cost implications as well as environmental implications because users may not only have to re-purchase items, but also produce waste which may pollute the environment. For the foregoing reasons, there may be a need for increasing the battery life of the aforementioned electronic devices.

### SUMMARY OF THE INVENTION

The present disclosure provides a method for improving battery life of electronic devices running on small batteries, for example coin batteries. The method may include wireless power transmission through suitable techniques such as pocket-forming, while including receivers and capacitors in the aforementioned devices.

In a system for wireless power transmission to improve battery life in a portable electronic device, comprising: a transmitter for generating RF waves having at least two RF antennas to transmit the generated RF waves through the antennas in constructive interference patterns; a micro-controller within the transmitter controlling the constructive interference patterns of generated RF waves to form pockets of energy in predetermined areas or regions in space; a receiver embedded within the portable electronic device with at least one antenna to receive the pockets of energy in the predetermined regions in space; a micro-controller within the receiver for communicating the power requirements of the portable electronic device to the micro-controller in the transmitter; and an auxiliary power supply within the receiver having a parallel connection to a main power supply in the portable electronic device wherein the auxiliary power supply is charged by the pockets of energy.

In an embodiment, an example of wireless power transmission through pocket forming may he provided.

In another embodiment, an electronic device including at least one embedded receiver and at least one capacitor for storing charge may be provided.

In an even further embodiment, a Bluetooth headset including at least one embedded receiver for wireless power transmission and at least one capacitor for storing charge, may be provided.

In another embodiment, a wristwatch including at least one embedded receiver for wireless power transmission, which may further include a built-in communications device and micro-controller, and at least one capacitor for storing charge may be provided.

In an even further embodiment, an algorithm for managing power loads on an electronic device including at least one main power supply, at least one embedded receiver and at least one capacitor as an auxiliary power supply may be provided.

The method here disclosed may provide wireless power to electronic devices such as headsets, smart-watches and the like. As described in embodiments above, such devices may include a capacitor or other suitable charge-storing devices, which upon discharge may power fully and/or partially the aforementioned devices. The foregoing method may decrease fully and/or partially power loads on a device's battery. Thus, battery life in such devices may be enhanced.

### BRIEF DESCRIPTION OF THE DRAWINGS

Embodiments of the present disclosure are described by way of example with reference to the accompanying figures, which are schematic and may not be drawn to scale. Unless indicated as representing prior art, the figures represent aspects of the present disclosure.

FIG. 1 illustrates wireless power transmission using pocket-forming, according to the present invention.

FIG. 2 illustrates powering of a typical portable electronic devices, according to the prior art.

FIG. 3 illustrates an electronic device including at least one embedded receiver and at least one auxiliary power supply for improving a portable electronic device's main power supply life, according to the invention of FIG. 1.

FIG. 4 illustrates an electronic device, as described in FIG. 3, in the form of a Bluetooth headset including at least one embedded receiver for providing wireless power transmission, according to the invention of FIG. 3.

FIG. 5 illustrates an electronic device, as described in FIG. 3, in the form of a wristwatch including at least one embedded receiver, for providing wireless power transmission, which may further include at least one built-in communications device and at least one micro-controller, according to the invention in FIG. 3.

FIG. 6 illustrates an algorithm for managing power loads on an electronic device, according to the invention of FIG. 3.

### DETAILED DESCRIPTION OF THE DRAWINGS

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RE waves.

“Transmitter” may refer to a device, including a chip which may generate two or more RF signals, at least one RE signal being phase shifted and gain adjusted with respect to other RE signals, substantially all of which pass through one or more RF antenna such that focused RF signals are directed to a target.

“Receiver” may refer to a device which may include at least one antenna, at least one rectifying circuit and at least one power converter for powering or charging an electronic device using RF waves.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of the present disclosure.

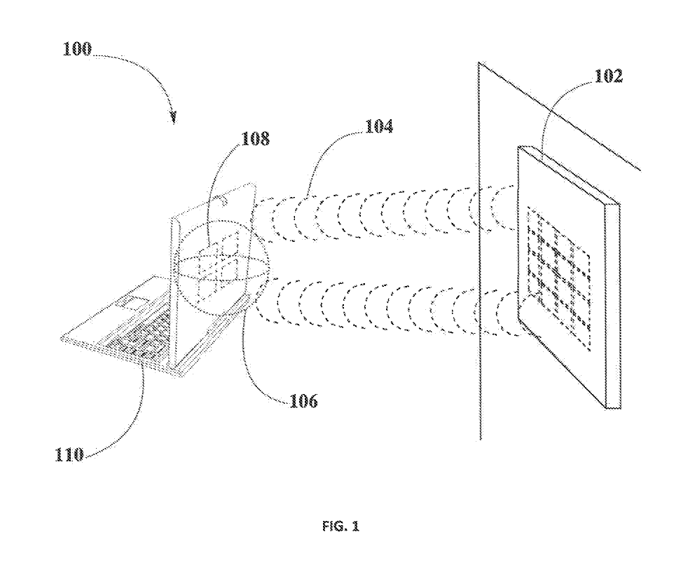

FIG. 1 illustrates wireless power transmission 100 using pocket-forming. A transmitter 102 may transmit controlled Radio Frequency (RE) waves 104 which may converge in 3-d space. These RF waves may be controlled through phase and/or relative amplitude adjustments to form constructive and destructive interference patterns (pocket forming). Pockets of energy 106 may form at constructive interference patterns and can be 3-dimensional in shape whereas null-spaces may be generated at destructive interference patterns. A receiver 108 may then utilize pockets of energy produced by pocket-forming for charging or powering an electronic device, for example a laptop computer 110 and thus effectively providing wireless power transmission. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

In an embodiment, transmitter 102 may include a housing where at least two or more antenna elements, at least one RF integrated circuit (RFIC), at least one digital signal processor (DSP) or micro-controller, and one communications component may be included. Transmitter 102 may also include a local oscillator chip for converting alternating current (AC) power to analog RF signals. Such RF signals may firstly be phase and gain adjusted through an RFIC proprietary chip, and then converted to RF waves via antenna elements. On the other hand, receiver 108 may include a housing where at least one antenna element, at least one rectifier and at least one power converter may be included. Receiver 108 may communicate with transmitter 102 through short RF waves or pilot signals sent through antenna elements. In some embodiments, receiver 108 may include an optional communications device for communicating on standard wireless communication protocols such as Bluetooth, Wi-Fi or Zigbee with transmitter 102. In some embodiments, receiver 108 may be implemented externally to electronic devices in the form of cases, e.g. camera cases, phone cases and the like which may connect trough suitable and well known in the art techniques such as universal serial bus (USB). In other embodiments, receiver 108 may be embedded within electronic devices.

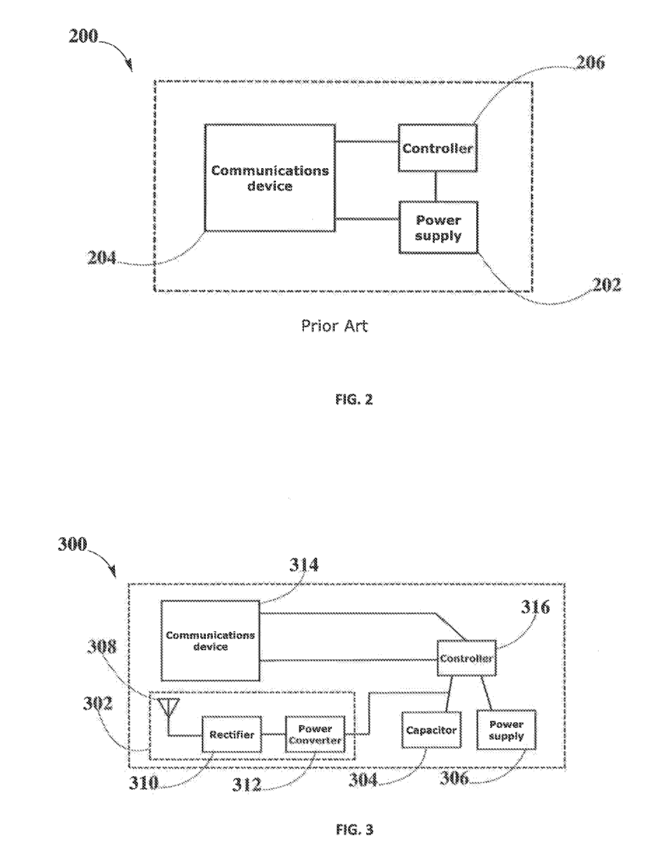

FIG. 2 illustrates prior art powering of an electronic device 200. Electronic device 200 may require a power supply 202 for powering its various components, for example a communications device 204 for wireless communication, a micro-controller 206 for function control, among other components not shown in FIG. 2. In an embodiment, electronic device 200 may represent a Bluetooth enabled headset running on power supply 202 in the form of a coin battery.

Power supply 202 may be the only power source on which electronic device 200 may run. Thus, when power supply 202 runs out, electronic device 200 may be unusable. The foregoing situation may be unpleasant to users who may depend heavily on their electronic devices and may therefore be forced to carry extra power supplies 202 in the form of batteries for example. In addition, if electronic device 200 does not allow for charging or replacing power supply 202, electronic device 200 may forever be inoperable, and thus, may turn into unnecessary waste.

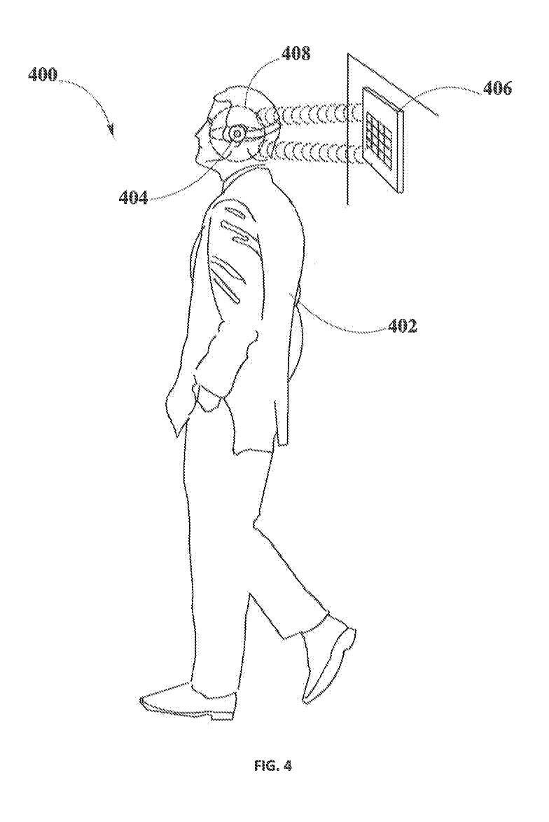

FIG. 3 illustrates an electronic device 300, similar to electronic device 200 described in FIG. 2 above, including at least one embedded receiver 302 and at least one auxiliary power supply 304 for improving the life of power supply 306. Embedded receiver 302, as described above in FIG. 1, may include at least one antenna element 308 for converting pockets of energy, produced through pocket-forming, into AC voltage, at least one rectifier 310 where AC voltage may be converted to direct current (DC) voltage, and at least on power converter 312 for providing constant DC voltage output to auxiliary power supply 304. In this embodiment, auxiliary power supply 304 can be a suitable charge storing device, for example a capacitor. Capacitors can he suitable auxiliary power supplies 304 because they can easily and cheaply be manufactured in small sizes. This foregoing property may be beneficial for small size devices.

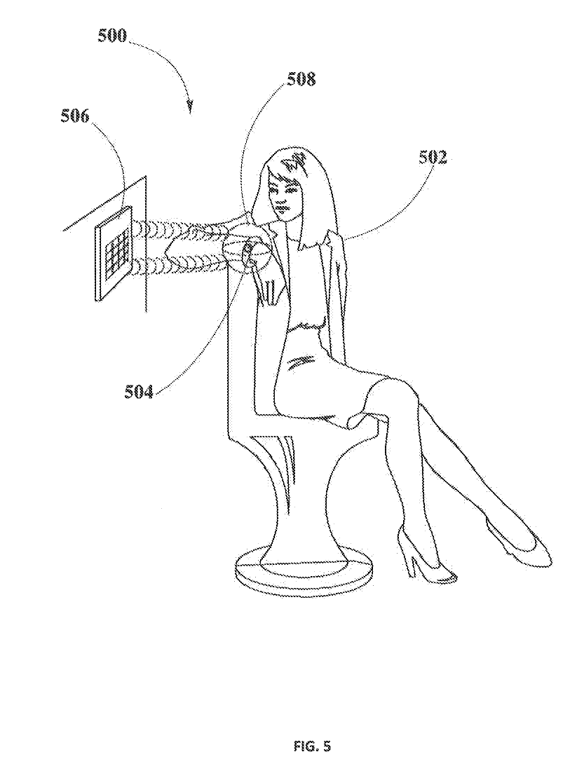

Auxiliary power supply 304 may fully or partially power electronic device 300, and thus may fully or partially decrease the power demand on power supply 306 from electronic device 300. The foregoing situation may extend power supply 306 life. In an embodiment, embedded receiver 302 may use a communications device 314 already embedded within electronic device 300 to communicate with a transmitter or other electronic devices as illustrated in FIG. 4 below. In other embodiments where electronic device 300 may not include such component, embedded receiver 302 may include a communications component on its own (as described in FIG. 5 below). In some embodiments, electronic device 300 may use a micro-controller 316 not only for controlling its intended functions, but also for managing power loads on auxiliary power supply 304 and/or power supply 306. In other embodiments, micro-controller 316 can be embedded within embedded receiver 302. The foregoing configuration may be beneficial when implementing receivers on electronic devices that may not typically include micro-controller 316, for example ordinary wristwatches.

FIG. 4 illustrates wireless power transmission 400 where an individual 402 wearing a Bluetooth enabled headset 404 may power such device, through pocket-forming, via a transmitter 406. Headset 404 may include an embedded receiver (not shown) for utilizing pockets of energy 408 for powering a capacitor (not shown) within headset 404 (as described in FIG. 3 above). In this embodiment, embedded receiver may utilize the built in Bluetooth chip for communicating wirelessly with transmitter 406. In addition, headset 404 may use its embedded micro-controller for managing the power loads between the capacitor and the built-in power supply of headset 404. In some embodiments, transmitter 406 may be located within a house or on other such buildings that individual 402 may frequent. In other embodiments, transmitter 406 may be placed inside the car of individual 402 for powering headset 404 while driving.

FIG. 5 illustrates wireless power transmission 500 where an individual 502 wearing a typical wristwatch 504 may power such device, through pocket-forming, via a transmitter 506. Wristwatch 504 may include an embedded receiver (not shown) for utilizing pockets of energy 508 for powering a capacitor (not shown) within wristwatch 504 (as described in FIG. 3 above). However, typical wristwatches, such as wristwatch 504, may not include a Bluetooth chip or a micro-controller as headset 404. In this case, embedded receiver may include an optional communications device as described in FIG. 1 and an embedded micro-controller. In this embodiment, communications device can be a Bluetooth chip.

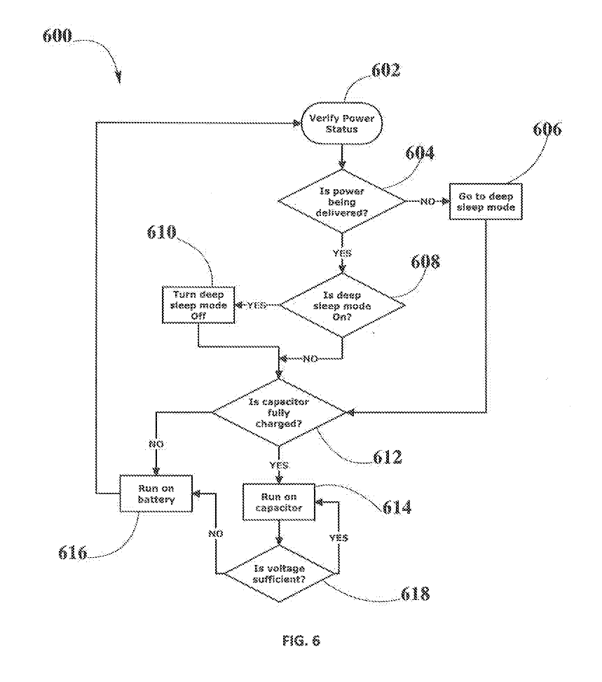

FIG. 6 illustrates an algorithm 600 which may be used by a controller, for example micro-controller 316, for managing power loads on auxiliary power supply 304 in the form of a capacitor and/or power supply 306 in the form of battery from electronic device 300 for example. Algorithm 600 may begin at a verify power step 602 where micro-controller 316 may determine whether power is being delivered to embedded receiver 302 from electronic device 300. Afterwards, micro-controller 316 may continue to a power decision step 604 where it may take the decision to proceed either to a deep sleep mode step 606 or to a deep sleep mode decision step 608 depending on the power delivery status. If power is not being delivered, micro-controller 316 may proceed to deep sleep mode step 606 where power saving may be prioritized. On the other hand, if power is being delivered, micro-controller 316 may proceed to a deep sleep mode decision step 608 where it may determine whether electronic device 300 is on deep sleep mode. If electronic device 300 is on deep sleep mode, then micro-controller 316 may proceed to turn deep sleep mode off step 610 where deep sleep mode may be turned off. Afterwards, micro-controller 316 may proceed to capacitor charge decision step 612. On the other hand, if electronic device 300 is not on deep sleep mode, micro-controller 316 may proceed directly to capacitor charge decision step 612. At capacitor charge decision step 612, micro-controller 316 may take the decision to proceed either to a run on capacitor step 614 or run on battery step 616. If auxiliary power supply 304 in the form of a capacitor is fully charged, micro-controller 316 may proceed to run on capacitor step 614 where a capacitor may provide power to electronic device 300. On the other hand, if auxiliary power supply 304 in the form of a capacitor is not fully charged, micro-controller 316 may proceed to run on battery step 616 where power supply 306 in the form of a battery may power electronic device 300. Referring back to run on capacitor step 614, a sub-routine may be added where micro-controller 316 may proceed to a voltage verification step 618, where it may, continuously or on predefined time intervals, verify the voltage across auxiliary power supply 304 to ensure that electronic device 300 may not turn off. If the voltage level across auxiliary power supply 304 is not sufficient for powering electronic device 300, micro-controller 316 may proceed to run on battery step 616. Otherwise, it may remain at run on capacitor step 614. In any circumstance where micro-controller 316 reaches run on battery step 616, the process may begin again to verify power delivery status and minimize the power load on power supply 306. In addition, when on deep sleep mode step 606, micro-controller 316 may proceed to capacitor charge decision step 612 to decide whether to run deep sleep mode on either power supply 306 or auxiliary power supply 304. In other embodiments of algorithm 600, micro-controller 316 may decide to power electronic device 300 using power supply 306 and auxiliary power supply 304 at the same time. This option may be beneficial when the power load on an electronic device is too large for a capacitor to handle. However, such a configuration may still diminish the power load on power supply 306. In other embodiments, a plurality of capacitors can be used as an auxiliary power supply 304 to compensate for power surges or high power demands.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method for wireless power transmission to improve battery life in a portable electronic device, comprising:
transmitting pockets of energy consisting of RF waves from a transmitter with at least two RF antennas and a transmitter communication device;
receiving the pockets of energy through a RF antenna in a receiver with a receiver communication device and a controller connected to the portable electronic device; and
converting the pockets of energy for charging an auxiliary power supply of the electronic device responsive to communication signals between the transmitter and receiver communication devices related to the power requirements of the portable electronic device.

2. The method for wireless power transmission to improve battery life in a portable electronic device of claim 1, further including rectifying the RF waves from the pockets of energy and converting the rectified RF waves into a constant DC voltage for charging the auxiliary power supply.

3. The method for wireless power transmission to improve battery life in a portable electronic device of claim 1, wherein the auxiliary power supply is a capacitor.

4. The method for wireless power transmission to improve battery life in a portable electronic device of claim 1, further including communicating between transmitter and receiver communication devices with short RF waves or pilot signals through the respective RF antennas and utilizing communication protocols of Bluetooth, Wi-Fi or Zigbee to carry information related to the power requirements of the portable electronic device.

5. A system for wireless power transmission to improve battery life in a portable electronic device, comprising:
a transmitter having at least two RF antennas in an array for generating pockets of energy;
a receiver with an RF antenna embedded in a portable electronic device for receiving the pockets of energy and for converting the pockets of energy into a constant DC voltage;
an auxiliary power supply for storing the constant DC voltage to fully or partially power the portable electronic device.

6. The system for wireless power transmission to improve battery life in a portable electronic device of claim 5, wherein the transmitter and receiver include micro-controllers for communicating therebetween with short RF waves or pilot signals through the respective RF antennas utilizing communication protocols of Bluetooth, Wi-Fi or Zigbee to carry information related to the power requirements of the portable electronic device.

7. The system for wireless power transmission to improve battery life in a portable electronic device of claim 5, wherein the auxiliary power supply is a capacitor for storing the constant DC voltage.

8. The system for wireless power transmission to improve battery life in a portable electronic device of claim 5, wherein the portable electronic device is a wristwatch, a headset or other portable electronic device running on small or coin size batteries for a main power supply.

9. The system for wireless power transmission to improve battery life in a portable electronic device of claim 6, wherein the portable electronic device includes a battery main power supply connected in parallel to the auxiliary power supply and wherein the micro-controller regulates the use of the auxiliary power supply to extend the battery life of the main power supply.

10. A system for wireless power transmission to improve battery life in a portable electronic device, comprising:
a transmitter for generating RF waves having at least two RF antennas to transmit the generated RF waves through the antennas in constructive interference patterns;
a micro-controller within the transmitter controlling the constructive interference patterns of generated RF waves to form pockets of energy in predetermined areas or regions in space;
a receiver embedded within the portable electronic device with at least one antenna to receive the pockets of energy in the predetermined regions in space;
a micro-controller within the receiver for communicating the power requirements of the portable electronic device to the micro-controller in the transmitter; and
an auxiliary power supply within the receiver having a parallel connection to a main power supply in the portable electronic device wherein the auxiliary power supply is charged by the pockets of energy.

11. The system for wireless power transmission to improve battery life in a portable electronic device of claim 10, wherein the micro-controller of the receiver verifies the power status requirements of the portable electronic device and determines if the auxiliary power supply is fully charged in order to fully or partially power the electronic device to decrease the power demand on the main power supply.

12. The system for wireless power transmission to improve battery life in a portable electronic device of claim 10, wherein the auxiliary power supply is a capacitor.

13. The system for wireless power transmission to improve battery life in a portable electronic device of claim 10, wherein the micro-controller on the receiver verifies status of the auxiliary and main power supplies and switches the auxiliary power supply between the states or rim and sleep modes depending on the state of charge on the auxiliary power supply.

14. The system for wireless power transmission to improve battery life in a portable electronic device of claim 10, wherein the micro-controllers communicate on standard wireless communication protocols of Bluetooth, Wi-Fi or Zigbee.

15. The system for wireless power transmission to improve battery life in a portable electronic device of claim 10, wherein the antennas operate in frequency bands of 900 MHz, 2.5 GHz or 5.8 GHz hands.

16. The system for wireless power transmission to improve battery life in a portable electronic device of claim 10, wherein the receiver includes a rectifier connected to the antenna for receiving the RF waves in the pockets of energy, a power converter connected to the rectifier to create a constant DC voltage for charging the auxiliary power supply connected to the power converter, the receiver micro-controller connected to the auxiliary and main power supplies which are connected in parallel to each other and wherein the status of each power supply is verified by the micro-controller and switched to supply power to the portable electronic device in order to extend the life of the main power supply.

17. The system for wireless power transmission to improve battery life in a portable electronic device of claim 11, wherein the micro-controllers are microprocessors or ASICs.

18. The system for wireless power transmission to improve battery life in a portable electronic device of claim 11, wherein the receiver micro-controller does a voltage verification to predefine time intervals for either the auxiliary power supply or the main power supply to power the portable electronic device.

19. The system for wireless power transmission to improve battery life in a portable electronic device of claim 11, wherein the auxiliary power is a capacitor and the main power supply is a battery and wherein the micro-controller verifies the power delivery status to minimize the power load on the battery.

20. A receiver for wireless power transmission to a portable electronic device, comprising:
an antenna for sending and receiving RF signals;
a rectifier connected to the antenna for rectifying alternating current from the RF waves received by the antenna to provide direct current;
a power converter connected to the rectifier for regulating the DC voltage for charging an auxiliary power supply or a battery associated with the portable electronic device;
a communication device for generating a communication RF signal identifying the auxiliary power supply and battery level of the electronic device; and
a micro-controller connected to the communication device and to the auxiliary and the battery power supplies to regulate predefined intervals of the auxiliary power supply or battery powering the portable electronic device.
